(19) United States
(12) Patent Application Publication
(10) Pub. No.: US 2017/0334533 A1
(43) Pub. Date: Nov. 23, 2017

(54) SOFT SHACKLE AND METHOD OF MAKING

(71) Applicant: Edward J. Herman, Annapolis, MD (US)

(72) Inventor: Edward J. Herman, Annapolis, MD (US)

(21) Appl. No.: 15/525,242

(22) PCT Filed: Nov. 9, 2015
(86) PCT No.: PCT/US15/59701

§ 371 Date: May 8, 2017

Related U.S. Application Data
(60) Provisional application No. 62/076,592, filed on Nov. 7, 2014.

(51) Int. Cl. B63H 9/10; F16G 11/14; F16G 11/04; A44B 1/18; B63B 21/08

(52) U.S. Cl. CPC B63H 9/10; F16G 11/14; F16G 11/046; B63B 21/08; A44B 1/18

(57) ABSTRACT

An improved button shackle (2) and method of making the same. The button shackle (2) generally comprises a single length of braided rope (3) noosed at one end by looping one end of the rope and running it back through itself, such that the end passes through the braids, to form a noose. The two ends of the rope are then woven together to form an eye, and a novel two-piece button (4) is inserted onto the eye. The two-piece button includes an inner disk (12) formed with opposing yokes (22, 24) for receiving the rope (3), and an outer collar (14) for holding the rope (3) captive once inserted into the yokes (22, 24).

### CROSS-REFERENCE TO RELATED APPLICATIONS

### Continuity

This application claims priority to and the benefit of U.S. Provisional Patent Application No. 62/076,592 filed 7 Nov. 2014, which is incorporated herein in their entirety by reference.

### FIELD OF THE INVENTION

This invention relates generally to sailboat rigging and, more particularly, to an improved soft shackle and method of making it.

### BACKGROUND OF THE INVENTION

Standing rigging on sailboats and yachts includes a network of ropes or cables used, among other things, to stay the mast. These ropes or cables are secured by a variety of sailing shackles, snaps and fittings. Conventional shackles, also known as gyves, are used to secure a rope, cable or chain to something and are a U-shaped piece of metal secured with a clevis pin or bolt across the opening, or a hinged metal loop secured with a quick-release locking pin mechanism. See, Admiralty Manual of Seamanship. 1995. pp. 3-80.

Conventional shackles are hard and potentially damaging when fluttering in the wind, and so the sailing industry has embraced the “soft shackle” for all types of sheets, jib and main halyards, or anywhere else that a shackle is needed. The common soft shackle is made with a single length of line noosed at one end where the lines running through each other, and knotted together at the other end. In use the knot is inserted through the noose, and the noose tightened to form a securing loop. Applicant developed a variation in which a button was used in lieu of a knot, as shown in U.S. Design patent 657,234 for “SOFT SHACKLE”.

The soft shackle is very light and is less likely to cause damage or injury. It is also reasonably strong, tested to about 175% of line strength. The knot is the weak point, and replacement of the knot with Applicant's previous button yields a higher-strength soft shackle tested to about 230% of line strength, but the aluminum button as originally designed induces sharp bends in the rope which undermine yield-strength, and also created friction/wear points which can lead to failure over time. Moreover, the button is exceedingly difficult to machine and using it the shackle is very difficult and expensive to manufacture.

What is needed is a button shackle that has absolutely no sharp edges or protrusions, is stronger than conventional designs, and yet is easy and economical to manufacture.

### SUMMARY

It is, therefore, an object of the invention to provide a more robust button shackle with absolutely no sharp edges or protrusions.

It is another object to provide a button shackle as described above that is stronger and more reliable than conventional designs.

It is another object to provide a method of making a button shackle as described above that is less laborious and more economical, lending itself to commercial production.

It is another object to provide a button shackle as described above in combination with an improved rigging block.

In accordance with the foregoing objects, the present invention is an improved button shackle and method of making the same. The button shackle generally comprises a single length of braided rope noosed at one end by looping one end of the rope and running it back through itself, such that the end passes through the braids, to form a noose. The two ends of the rope are then woven together to form an eye, and a novel two-piece button is inserted onto the eye. The two-piece button includes an inner disk formed with opposing yokes for receiving the rope, and an outer collar for holding the rope captive once inserted into the yokes.

The improved method of making entails machine-tightening the continuous loop of rope, installing the inner disk midway along the rope by seating the opposing strands of rope into the two opposing yokes of the inner disk, sliding the inner disk all the way to the tip of the eye of the rope, and then installing the outer collar.

The improved button shackle and method of making described herein is stronger than conventional designs, is more manufacturable, and is better able to avoid loosening and/or dislodgement as a result of impact or vibration.

A button shackle as described above in combination with a modified rigging block is also disclosed.

Other objects, features, and advantages of the present invention will become more apparent from the following detailed description of the preferred embodiments and certain modifications thereof when taken together with the accompanying drawings.

### DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a perspective view of a button shackle 2 in accordance with the invention.

FIG. 2 is a composite view (A & B) of the inner disk 12 used in the two-piece button 4 of the button shackle 2 of FIG. 1.

FIG. 3 is a composite view (A & B) of the outer collar 14 used in the two-piece button 4 of the button shackle 2 of FIG. 1.

FIG. 4 is a perspective illustration showing a button shackle 2 as described above used in combination with a modified T8 rigging block.

### DESCRIPTION OF THE INVENTION

Reference will now be made in detail to preferred embodiments of the present invention, examples of which are illustrated in the accompanying drawings. Wherever possible, the same reference numbers will be used throughout the drawings to refer to the same or like parts.

The present invention is an improved button shackle having a more robust and reliable design with absolutely no sharp edges or protrusions to chaff or tear sails or rigging. The button shackle is stronger and much more reliable than conventional designs.

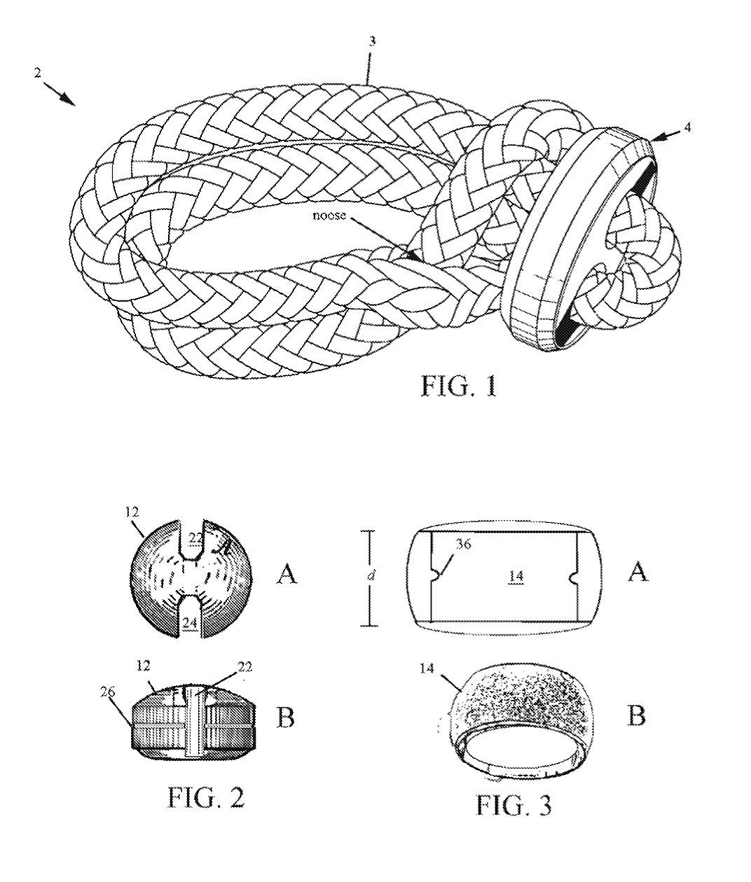

FIG. 1 is a perspective view of a button shackle 2 in accordance with the invention.

FIG. 2 is a composite view (A & B) of the inner disk 12 used in the two-piece button 4 of the button shackle 2 of FIG. 1.

FIG. 3 is a composite view (A & B) of the outer collar 14 used in the two-piece button 4 of the button shackle 2 of FIG. 1.

As seen collectively in FIGS. 1-3, the present invention is an improved button shackle 2 and method of making the same, generally comprising a loop of braided rope 3 and a two-piece button 4. The braided rope 3 originates from a pre-determined length of braided rope such as, for example, ultra-high-molecular-weight polyethylene cord such as Dyneema® or Spectra®, although Nylon or cotton rope will suffice. The rope 3 is noosed at one end by looping one end of the rope around and running it back through itself, such that the end passes through the braids, to form a noose. The two distal ends of the rope are then woven together at an eye to form a continuous loop. In accordance with the invention, a novel two-piece button 4 is inserted onto the eye. The two-piece button 4 includes an inner disk 12 formed with opposing yokes 22, 24 for receiving the rope 3, and an outer collar 14 for holding the rope 3 captive once inserted into the yokes 22, 24. Inner disk 12 is preferably made of aluminum, and the opposing yokes 22, 24 are machined by drilling two offset holes from the center and cutting outward to continue the holes, making them open-ended. This ensures that the inward surfaces of the yokes are rounded to receive and seat the rope 3 without abrasion. At least the upper face of the inner disk 12 is convex, and more preferably both faces are convex. The outer collar 14 is a bangle-shaped collar with cylindrical interior aperture sized to exactly conform to inner disk 12. Importantly, the exterior surface of the inner disk 12 is formed with an inwardly-protruding circular notch 26 substantially circumscribing the inner disk 12 but interrupted by yokes 12, 14. Likewise, the interior surface of the outer collar 14 is formed with an outwardly-protruding circular rib 36 completely circumscribing the inner surface of outer collar 14, and adapted for seating within the notch 26 of inner disk 12 to center and secure the collar 14 onto the disk 12. The outside surfaces of collar 14 may be flat or convex. Importantly, every edge of both disk 12 and collar 14 is chamfered or rounded to avoid abrasion and cutting. Collar 14 is preferably molded of a durable yet lightweight polymer such as polyoxymethylene (a.k.a. acetal resin and sold under the brand names such as Delrin® and Celcon). When collar 14 is seated on the inner disk 12 the combination fully bounds both yokes 22, 24, essentially turning them into two (2) holes.

The improved method of making the improved button shackle 2 entails the following steps:

1) procure a length of braided cord such as, for example, 3/16 braided Dyneema®. For example, a 4″ inch long open button shackle measured from tip-to-tip will require about 15 inches of cord.

2) Mark the cord dead center, then mark the cord in two places offset 1″ from dead center;

3) tape off both distal ends of the cord;

4) insert a pick at one of the two offset marks and enlarge a hole through the braids;

5) insert the furthest end of the rope (taped) through the hole and pull tight until an approximate 1″ diameter noose exists;

6) untape the ends;

7) splice the ends of the rope together to form a continuous loop, now appearing as a figure eight;

8) insert the continuous loop of rope into a tensioning jig.

9) while under tension, install the inner disk 12 midway along the continuous loop by pressing the rope into the yokes 22, 24.

10) pull/slide the inner disk 12 all the way down the loop to the eye;

11) install the collar 14 until its circular rib 36 seats within the notch 26 of inner disk 12.

A finished button shackle 2 is the result, which has absolutely no sharp edges or protrusions, is stronger than conventional designs, and yet is easy and economical to manufacture.

It should now be apparent that the above-described button shackle design is more aesthetically pleasing, has absolutely no damaging sharp edges or protrusions, and yet is stronger and more reliable than conventional designs. Those skilled in the art will understand that various modifications and variations can be made in the present invention without departing from the spirit or scope of the invention.

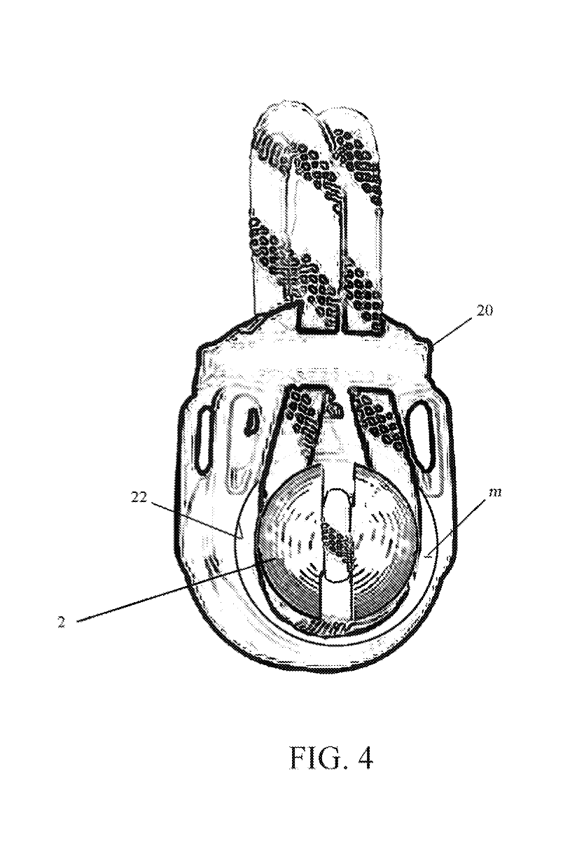

For example, FIG. 4 is a perspective illustration showing a button shackle 2 as described above used in combination with a modified T8 rigging block 20. It is known that conventional soft shackles can be used in combination with rigging blocks. The combination of the button shackle 2 as described herein when used with a rigging block can be greatly improved by forming one of the faces of the rigging block 20 with an enlarged circular recess 22 for seating two-piece button 4. The recess 22 continues through a smaller hole through the rigging block 20. The diameter of the circular recess 22 is preferably slightly larger than the diameter of the outer collar 14 (as seen in FIG. 3a) so as to leave an open margin m (see FIG. 4) within which to lasso the recessed button 12. The floor of the circular recess 22 is sculpted to conform to the downside of button 12. The outer collar 14 may, for this embodiment, be formed with a concave periphery for seating the braided rope 3. The depth of the circular recess 22 is slightly less than the total thickness d of the button 12 so that when the button 12 is seated in the recess 22 the concave side of button 12 is flush with the outer face of block 20. In use, the end of the button shackle 2 is inserted through the circular recess 22 and through the hole of the block 20 in a conventional manner and is looped back around and lassoed over the button 12. When pulled tight, the button 12 of button shackle 2 seats flush within recess 22 and this serves to prevent injury and avoids frayed rope.

It is to be understood, therefore, that the invention may be practiced otherwise than as specifically set forth in the appended claims.

### STATEMENT OF INDUSTRIAL APPLICABILITY

Soft shackles are very popular amongst sailors because they are extremely strong, comparatively lightweight, soft, and low-profile. Owing to these soft shackles are far less likely to cause any damage or injury. Button shackles are a particular type of soft shackle that use an aluminum button for a head. The button has two holes in it for the rope loop to pass through, but this means that the rope must be threaded through the button first, and then tied in its figure-eight loop. This is cumbersome and labor intense, There would be great industrial applicability in simplifying assembly with a soft button shackle that employs a novel two-piece button that facilitates splicing the rope together in a continuous loop, installing the rope to one piece of the two-piece button, and then attaching the other piece of the two-piece button to complete the assembly.

What is claimed is:

1. A button shackle, comprising:
a single length of braided rope noosed at one end by looping one end of the rope and running it back through itself, such that the end passes through the braids, to form a noose, and the distal ends spliced together at an eye; and
a two-piece button seated on the eye of said rope, said two-piece button including an inner disk formed with opposing yokes for receiving the rope, and an outer collar for holding the rope captive once inserted into the yokes.

2. A method of making a button shackle, comprising the steps of:
forming a noose in a length of braided rope by looping one end of the rope and running it back through itself, such that the end passes through the braids, to form a noose;
splicing the distal ends of the rope together at an eye to form a continuous loop;
installing an inner disk midway along the rope, said inner disk being formed with opposing yokes for receiving the rope;
sliding the inner disk onto the eye;
fitting an outer collar over the inner disk and rope to fully bound both opposing yokes, turning them into holes.

3. A rigging apparatus, comprising:
a button shackle including a single length of braided rope noosed at one end by looping one end of the rope and running it back through itself, such that the end passes through the braids, to form a noose, and the distal ends spliced together at an eye, and
a two-piece button seated on the eye of said rope, said two-piece button including an inner disk formed with opposing yokes for receiving the rope, and an outer collar for holding the rope captive once inserted into the yokes; and
a rigging block formed with a hole there through, said hole exiting on one side through an enlarged circular recess conforming to said button and having a diameter slightly larger than a diameter of said outer collar, for seating said button flush.
